(19) United States
(12) Patent Application Publication
(10) Pub. No.: US 2004/0183639 A1
(43) Pub. Date: Sep. 23, 2004

(54) High density coil

(76) Inventors: Noriyoshi Okura, Saitama (JP); Akihiro Sakashita, Saitama (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/731,143

(22) Filed: Dec. 10, 2003

(30) Foreign Application Priority Data
Dec. 12, 2002 (JP) 2002-360569

(51) Int. Cl. H01F 27/28

(52) U.S. Cl. 336/180

(57) ABSTRACT

It is a high density coil and a method for manufacturing a high density coil in which the high density coil has a wire bundle wherein a self-fusible insulated wire having an oval or hexagonal cross section is wound without a space and the wire bundle has a substantially honeycomb cross section.

### TECHNICAL FIELD OF THE INVENTION

The present invention relates to a high density coil for use in, e.g., an electronic device.

### DESCRIPTION OF RELATED ART

Heretofore, a conduction density of a coil for use in, e.g., an electronic device has been required to be high for increasing an efficiency of the coil. Usually, a regularly-wound coil formed of an insulated round wire is used. However, when the insulated round wire is coiled, a space is generated between windings of the coil. Therefore, the increase in the conduction density of the coil is limited.

Consequently, it has been suggested that the coil is manufactured by molding the insulated round wire into a flat wire by use of a reduction roll.

### SUMMARY OF THE INVENTION

When an insulated round wire is rolled into a flat wire, an abnormal strain occurs in the insulated coating film, which is thereby destroyed. In particular, a corner of the insulated coating film tends to be destroyed. Additionally, because it is difficult that an insulated round thin wire having a diameter equal to or under 0.1 mm is rolled into the flat wire, a compact coil for an electronic device can be hardly obtained. The coil formed of such a flat wire has a low reliability. However, when the insulated round wire is wound, a space is generated between windings of the coil, and thus a wire area ratio is limited to about 90 percent. As a result, neither a conduction density of the coil nor an efficiency of the coil can be further increased.

For solving these problems, the present invention increases the wire area ratio to the maximum to provide a reliable coil. For this purpose, the present invention relates to a high density coil comprising a wire bundle, in which a self-fusible insulated wire having an oval or hexagonal cross section is wound without a space, and which has a substantially honeycomb cross section. The winding of the self-fusible insulated wire may be regular winding.

An insulated coating film of the self-fusible insulated wire may be formed of a resin selected from the group consisting of a polyimide resin, a polyamideimide resin, a polyesterimide resin, a polyurethane resin and a polyester resin, and the coating film may be coated with a self-fusible resin to form the insulated wire. Two or more of the high density coils may be combined with each other at outer edges thereof.

A high density coil according to the invention may also be manufactured by disposing a core and, if necessary, an outer flame on a pedestal; fitting, to a core, a coil formed by regularly winding a self-fusible insulated round wire and pressing the coil in a winding width direction of the coil, and crushing a space between windings of the coil so that a cross section of a wire bundle forming the coil may be a substantially honeycomb shape. Alternatively, the high density coil according to the invention may be manufactured by fitting, to a core, a coil formed by regularly winding a self-fusible insulated round wire, applying an outer flame to an outer diameter of the coil, and pressing the coil in a winding thickness direction of the coil by using a pressure applicator, and crushing a space between windings of the coil so that a cross section of a wire bundle forming the coil may be a substantially honeycomb shape. In this case, the outer frame may be disposed on a pedestal. The outer frame may be another coil.

### BRIEF DESCRIPTION OF THE DRAWINGS

FIG. 1 is an explanatory view of a manufacturing apparatus for a coil of the invention.

FIG. 2 is an explanatory view of a coil having a wire bundle formed of an insulated wire whose cross section is pressed into an oval shape.

FIG. 3 is an explanatory view of a coil having a wire bundle formed of an insulated wire whose cross section is pressed into a hexagonal shape.

### DETAILED DESCRIPTION OF THE INVENTION

Even when a coil is formed by regularly winding a self-fusible insulated round wire as compactly as possible, a wire area ratio of the coil theoretically reaches about 90 percent at the maximum.

On the other hand, in the case of a flat wire, a wire area ratio of the coil theoretically reaches 100 percent. In fact, because the flat wire is formed by rolling the round wire, a corner of the flat wire has an insufficiently angular shape. As a result, the wire area ratio of the coil is practically limited to about 95 percent, and thus a space remains in the coil.

Additionally, a ratio of a longitudinal diameter to a transverse diameter of the flat wire is limited to 1:20, so that a degree of design freedom of the coil is low.

The present invention is a high density coil formed of a wire bundle in which a self-fusible insulated wire having an oval or hexagonal cross section is wound without a space and which has a substantially honeycomb cross section. This coil can be produced by pressing a regularly-wound coil formed of a self-fusible insulated round wire, deforming a cross section of the coil wire into an oval or hexagonal shape, and crushing a space between windings of the coil. In such a manner, a wire area ratio of the coil is increased. When the coil is pressed, the round wire is first deformed, so that the space of the coil is crushed. When pressure is further applied to the coil, the coil is received in a pedestal and a pressure wall. The wire area ratio of this coil becomes almost a maximum value.

Therefore, the coil may be designed considering a direct current resistance, the number of windings, and a wire area ratio of 100 percent, so that an extremely high degree of the design freedom is achieved.

As shown in FIG. 1, in a molding tool for molding a coil by press, a core 2 having an inner diameter of a coil 4 is disposed on a pedestal 1 of a molding die for extruding a coil. An outer flame 3 can move toward the core by receiving an external force, and for example, a split mold is used. A hollow portion of the regularly wound coil 4 is mounted to the core of this mold. Then, the flame is moved toward the core to press the coil from a periphery thereof.

When the flame is moved toward the core to press the coil in a winding thickness direction of the coil, a winding thickness precision of the coil is increased, whereby there can be obtained an effect that the disposition of a clearance is not required any more between the adjacent coils when the coils are flatly disposed.

Additionally, a hollow portion of the coil formed in a manner that a diameter of the coil is rather smaller than a diameter of the outer flame 4 may be fitted to the core by use of the outer flame 3 fixed to a predetermined completion size of a coil, and the coil may be pressed from the above by a pressure applicator 5 to mold the coil. In this case, another coil can be used as the outer flame 3. In this case, the coil is pressed, so that it expands outward and contacts the outer flame to receive a pressing force.

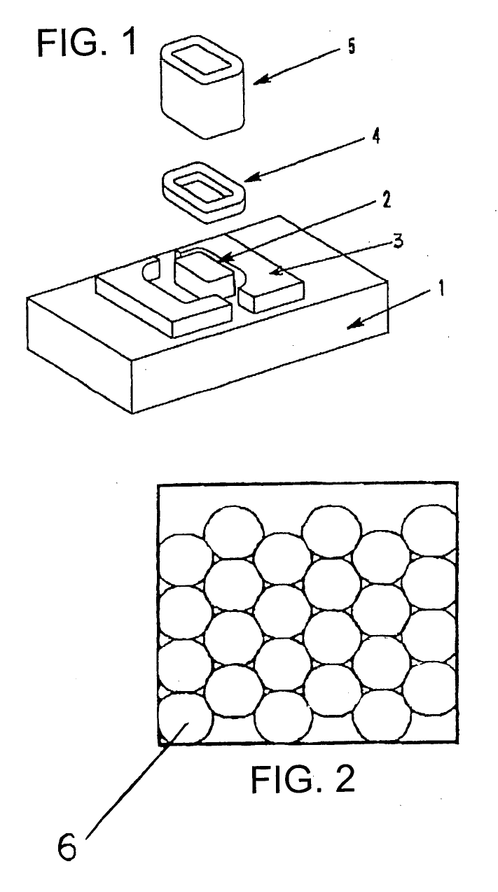

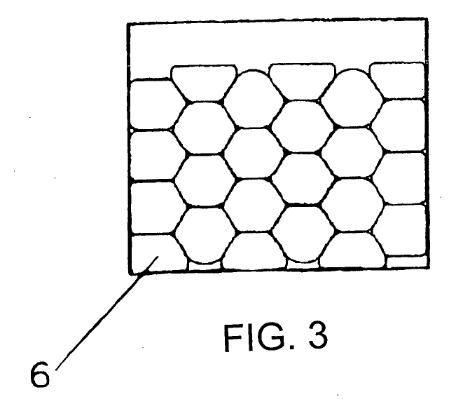

Because the coil of the present invention is formed by molding the coil formed of the insulated round wire, there is an effect that, when characteristics such as a size of a specific portion of the coil and magnetism of the coil are to be guaranteed, the coil can be partially deformed in accordance with the characteristics. When the coil is pressed in such a manner, a front surface of the insulated wire forming the coil is deformed into the oval shape as shown in FIG. 2, or into the hexagonal shape as shown in FIG. 3. Then, the space between the wire bundles of the coil is crushed to produce the high density coil formed of a wire bundle 6 having the almost honeycomb cross section.

An amideimide resin or an esterimide resin is preferably used for the insulated coating film of the insulated round wire used in the present invention, but a polyester resin, a polyurethane resin or the like can also be used. The round wire can be used in which this kind of insulated coating film is coated with the self-fusible coating film mainly containing the polyamide resin.

When the insulated wires having these structures are pressed and molded, the insulated coating films of the wires are not destroyed.

Next, some examples will be described. Measured values are shown in Table 1.

### EXAMPLES

### Example 1

A polyester resin having a film thickness of 0.005 mm was applied and baked onto a copper wire having a core wire diameter of 0.28, and the copper wire was coated with a polyamide self-fusible coating film, whereby a self-fusible wire having a completion outer diameter of 0.30 was produced. This self-fusible wire was wound into a coil having 242 (11 columns×22 layers) windings. This coil was fitted to the core 2 on the pedestal 1 of the apparatus shown in FIG. 1, and then pressed in a thickness direction of the coil by the pressure applicator 3, whereby a winding width of the coil was reduced by 6.4 percent.

As shown in FIG. 2, the cross section of the wire bundle in which the cross section of the insulated wire was deformed into the oval shape became the honeycomb shape, so that a coil thickness was 2.23 mm and a coil width is 5.50 mm. A space between the insulated wires was reduced by about ⅓, which means that the space became very small.

### Example 2

The same coil as used in Example 1 was fitted to a core 2 of a pedestal 1 of an apparatus shown in FIG. 1, and then pressed by an outer flame 5 and a pressure applicator 3 in a diameter direction and a thickness direction of the coil, whereby a winding width of the coil was reduced by 9.1 percent. As shown in FIG. 3, the coil has a hexagonal cross section and a wire bundle having a honeycomb cross section, and a coil thickness is 3.13 mm and a coil width is 5.50 mm. As a result, a space between windings of the insulated wire becomes substantially zero.

The present invention has the following excellent effects. A space between windings of a coil becomes substantially zero; a wire area ratio of the coil is increased; an efficiency of the coil is increased; a degree of design freedom of the coil increases; and miniaturization of the coil is possible.

The disclosure of Japanese Patent Application No. 2002-360569 filed Dec. 12, 2002 including specification, drawings and claims is incorporated herein by reference in its entirety.

Although only some exemplary embodiments of this invention have been described in detail above, those skilled in the art will readily appreciated that many modifications are possible in the exemplary embodiments without materially departing from the novel teachings and advantages of this invention. Accordingly, all such modifications are intended to be included within the scope of this invention.

What is claimed is:

1. A high density coil comprising a wire bundle in which a self-fusible insulated wire having an oval or hexagonal cross section is wound without a space and which has a substantially honeycomb cross section.

2. The high density coil according to claim 1, wherein the winding of the self-fusible insulated wire is regular winding.

3. The high density coil according to claim 1, wherein an insulated coating film of the self-fusible insulated wire is formed of a resin selected from the group consisting of a polyimide resin, a polyamideimide resin, a polyesterimide resin, a polyurethane resin and a polyester resin, and the coating insulated film is coated with a self-fusible resin to form the insulated wire.

4. A high density coil according to claim 3 wherein outer edges of two or more of the high density coils are joined with each other.

5. A method of manufacturing a high density coil, comprising the steps of:
disposing a core and, if necessary, an outer flame on a pedestal;
fitting, to a core, a coil formed by regularly winding a self-fusible insulated round wire and pressing the coil in a winding width direction of the coil; and
crushing a space between windings of the coil so that a cross section of a wire bundle forming the coil may be a substantially honeycomb shape.

6. A method of manufacturing a high density coil, comprising the steps of:
fitting, to a core, a coil formed by regularly winding a self-fusible insulated round wire, applying an outer flame to an outer diameter of the coil, and pressing the coil in a winding thickness direction of the coil by using a pressure applicator; and
crushing a space between windings of the coil so that a cross section of a wire bundle forming the coil may be a substantially honeycomb shape.

7. The method of manufacturing a high density coil according to claim 6, wherein the outer flame disposed on a pedestal is another coil.
